(19) United States
(12) Patent Application Publication
(10) Pub. No.: US 2026/0243406 A1
(43) Pub. Date: Aug. 20, 2026

(54) LIGHT GUIDE STRUCTURE OF SIDE TURN SIGNAL LAMP

(71) Applicant: MURAKAMI CORPORATION, Shizuoka (JP)

(72) Inventor: Dinh Van DONG, Yaizu-shi (JP)

(73) Assignee: MURAKAMI CORPORATION, Shizuoka (JP)

(21) Appl. No.: 19/535,301

(22) Filed: Feb. 10, 2026

(30) Foreign Application Priority Data
Feb. 20, 2025 (JP) 2025-025559

(51) Int. Cl. F21S 45/70; F21S 43/19; F21S 43/236; F21S 45/10; F21W 103/20

(52) U.S. Cl. CPC F21S 45/70; F21S 43/19; F21S 43/236; F21S 45/10; F21W 2103/20

(57) ABSTRACT

A light guide structure includes a light leakage prevention structure. The light leakage prevention structure includes a plate-shaped portion integrated with a light guide portion in such a manner that the plate-shaped portion is connected to one end side of the light guide portion where an incident surface is disposed and extends in a plane direction parallel or non-parallel to the incident surface. The plate-shaped portion includes an inclined surface on a front face of the plate-shaped portion at a position adjacent to an outer peripheral face of the light guide portion, the inclined surface being concavely inclined toward the outer peripheral face of the light guide portion.

The disclosure of Japanese Patent Application No. 2025-025559 filed on Feb. 20, 2025 including the specification, drawings, claims and abstract is incorporated herein by reference in its entirety.

### BACKGROUND OF THE INVENTION

### Field of the Invention

The present invention relates to a light guide structure of a side turn signal lamp mounted on a vehicle, and restrains light that deviates from a predetermined optical axis of the light guide structure near an incident surface of the light guide structure from leaking to outside of the side turn signal lamp.

### Description of the Related Art

Some side turn signal lamps of vehicles include a light guide structure incorporated therein. This light guide structure is configured to allow light from a light source inside the side turn signal lamp to enter the light guide structure through a predetermined incident surface, guide the light, and radiate the light toward an external environment from a predetermined radiation surface. Examples of the conventional light guide structure are described in Japanese Patent Laid-Open No. 2015-229386, Japanese U.S. Pat. No. 6,003,177, and Japanese Patent Laid-Open No. 2021-097013.

The conventional light guide structure has such a problem that light that deviates from the predetermined optical axis of the light guide structure near the incident surface leaks to outside of the side turn signal lamp from a place other than the radiation surface and is visually recognized from an external environment. Thus, to solve this problem, it is necessary to block the light deviating from the optical axis of the light guide structure, for example, by disposing a light-blocking sheet near the incident surface of the light guide structure.

The present invention provides a light guide structure of a side turn signal lamp that solves the problem in prior art described above and restrains light deviating from a predetermined optical axis of the light guide structure from leaking to outside of the side turn signal lamp from a place other than the radiation surface.

### SUMMARY OF THE INVENTION

A light guide structure of the present invention includes: a light guide portion incorporated in a side turn signal lamp, the light guide portion being configured to allow light from a light source of the side turn signal lamp to enter the light guide portion through a predetermined incident surface, guide the light, and radiate the light toward an external environment from a predetermined radiation surface; and a light leakage prevention structure, in which the light leakage prevention structure includes a plate-shaped portion integrated with the light guide portion in such a manner that the plate-shaped portion is connected to one end side of the light guide portion where the incident surface is disposed and extends in a plane direction parallel or non-parallel to the incident surface, and the plate-shaped portion includes an inclined surface on a front face of the plate-shaped portion at a position adjacent to an outer peripheral face of the light guide portion, the inclined surface being concavely inclined toward the outer peripheral face of the light guide portion. According to this, since at least part of light deviating from an optical axis of the light guide portion near the incident surface of the light guide portion is totally reflected by the inclined surface of the plate-shaped portion and travels within the plate-shaped portion, it is possible to restrain the light deviating from the optical axis from leaking to outside of the side turn signal lamp.

In the light guide structure of the present invention, the incident surface may have a circular shape, and the inclined surface may be formed in a mortar shape surrounding the incident surface. According to this, since at least part of light deviating in each radiation direction around the incident surface from the optical axis of the light guide portion near the incident surface is totally reflected by the inclined surface formed in the mortar shape surrounding the incident surface and travels within the plate-shaped portion, it is possible to restrain the light deviating from the optical axis from leaking to outside of the side turn signal lamp.

The light guide structure of the present invention may further include a light-blocking wall disposed facing an outer peripheral end face of the plate-shaped portion. According to this, light that deviates from the optical axis of the light guide portion near the incident surface of the light guide portion, and is totally reflected by the inclined surface of the plate-shaped portion and travels within the plate-shaped portion is blocked by the light-blocking wall when the light is emitted from the outer peripheral end face of the plate-shaped portion. Thus, it is possible to more reliably restrain the light from leaking to the outside of the side turn signal lamp.

In the light guide structure of the present invention, the light guide portion may include a bend portion that bends an optical axis of the light guide portion with roundness in such a manner that the incident surface faces forward or obliquely forward of the side turn signal lamp. According to this, since a circuit board equipped with the light source can be disposed in a position nearly parallel to the front face of the side turn signal lamp, the thickness of the side turn signal lamp can be made thinner than that in a case in which the circuit board is disposed in a position nearly at a right angle relative to the front face of the side turn signal lamp due to the absence of the bend portion or a shallow bending angle. Thus, it is possible to easily design an arrangement that prevents mutual interference between the side turn signal lamp and other devices when the side turn signal lamp is disposed and housed in a side mirror or the like. In addition, since the incident surface is disposed facing forward or obliquely forward of the side turn signal lamp, when light deviating from the optical axis of the light guide portion near the incident surface of light guide portion attempts to travel in the forward or oblique forward direction of the side turn signal lamp, at least part of the light deviating from the optical axis of the light guide portion is totally reflected by the inclined surface and travels within the plate-shaped portion. Thus, it is possible to restrain the light from traveling in the forward or oblique forward direction of the side turn signal lamp and restrain the light from leaking to the outside of the side turn signal lamp.

In the light guide structure of the present invention, the incident surface and the inclined surface may be disposed at a position that is not visible from the external environment in a state in which the side turn signal lamp is mounted on a vehicle. According to this, since the incident surface and the inclined surface are disposed at the position that is not visible from the external environment in a state in which the side turn signal lamp is mounted on a vehicle, it is possible to more reliably restrain light deviating from the optical axis of the light guide portion near the incident surface of the light guide portion from being visually recognized from the external environment.

In the light guide structure of the present invention, the plate-shaped portion may constitute a part of a lamp cover, the lamp cover being attached to and covering a lamp housing in which a circuit board equipped with the light source is disposed in the side turn signal lamp to form a lamp chamber between the lamp cover and the lamp housing and to shield the lamp chamber from the external environment, and the plate-shaped portion may be disposed facing the circuit board and the incident surface may be disposed facing the light source in a state in which the lamp cover is attached to and covers the lamp housing. According to this, since the light guide portion is integrated with the lamp cover, the number of parts can be reduced compared to a case in which the light guide portion and the lamp cover are configured as separate components.

In the light guide structure of the present invention, an outer peripheral end face of the plate-shaped portion may be disposed facing an inner peripheral face of an outer peripheral wall of the lamp housing in a state in which the lamp cover is attached to and covers the lamp housing. According to this, light that deviates from the optical axis of the light guide portion near the incident surface of the light guide portion, and is totally reflected by the inclined surface of the plate-shaped portion and travels within the plate-shaped portion is blocked by the outer peripheral wall of the lamp housing (or a bonding agent filled between the outer peripheral end face of the plate-shaped portion and the outer peripheral wall of the lamp housing) when the light is emitted from the outer peripheral end face of the plate-shaped portion. Thus, it is possible to restrain the light from leaking to the outside of the side turn signal lamp.

### BRIEF DESCRIPTION OF THE DRAWINGS

FIG. 1 is a diagram showing an embodiment of a side turn signal lamp (hereinbelow, abbreviated as “turn lamp”) to which the present invention is applied, the diagram being an exploded perspective view showing the turn lamp in FIG. 4 (A to F) disassembled into components;

FIG. 2A is a perspective view showing a physical type side mirror for the vehicle right side (a door mirror using a physical mirror) with the turn lamp in FIG. 4 (A to F) assembled thereto (shown with a lower cover of a visor detached), viewed from the front oblique side (the side closer to a vehicle body);

FIG. 2B is a perspective view of the side mirror in FIG. 2A viewed from the back oblique side (the side farther from the vehicle body) (shown with the lower cover of the visor detached, as with FIG. 2A);

FIG. 3A is a partial enlarged view of FIG. 2B (shown with the lower cover of the visor attached) and an enlarged view of an area enclosed by a dashed line in the partial enlarged view;

FIG. 3B is a partial sectional view at an A arrow view position in FIGS. 2B and 3A (shown with the lower cover of the visor attached) and an enlarged view of an area enclosed by a dashed line in the partial sectional view (also showing a light path of light emitted from a light source);

FIG. 3C is an enlarged sectional view at a B arrow view position in FIGS. 2B and 3A (shown with the lower cover of the visor attached and an upper cover detached);

FIG. 4A is a front view showing an assembled state of the turn lamp in FIG. 1;

FIG. 4B is a back view of the turn lamp in FIG. 4A;

FIG. 4C is a plan view of the turn lamp in FIG. 4A;

FIG. 4D is a bottom view of the turn lamp in FIG. 4A;

FIG. 4E is a left side view of the turn lamp in FIG. 4A;

FIG. 4F is a right side view of the turn lamp in FIG. 4A;

FIG. 5A is a front view of a lamp cover (outer lens) in FIG. 1;

FIG. 5B is a sectional view at an A arrow view position in FIG. 5A (same as the A arrow view position in FIGS. 2B and 3A);

FIG. 5C is a sectional view at a B arrow view position in FIG. 5A (same as the B arrow view position in FIGS. 2B and 3A);

FIG. 5D is a sectional view at a C arrow view position in FIG. 5B and an enlarged view of an area enclosed by a dashed line in the sectional view;

FIG. 5E is a sectional view at a D arrow view position in FIG. 5B;

FIG. 6A is a simulation diagram showing ray tracing of light emitted from the light source, with respect to the turn lamp in FIG. 4 (A to F), the turn lamp being viewed from front and obliquely above;

FIG. 6B is a simulation diagram showing a state of the ray tracing in the simulation of FIG. 6A, viewed from the obliquely front right side of the turn lamp;

FIG. 7A is a simulation diagram showing, as a comparative example of FIG. 6 (A, B), ray tracing of light emitted from the light source, with respect to a turn lamp in which a band-shaped surface of a light guide portion is eliminated from the turn lamp in FIG. 4 (A to F) (a place of the band-shaped surface is also formed as an arc-shaped surface), the turn lamp being viewed from front and obliquely above (the same direction as FIG. 6A);

FIG. 7B is a simulation diagram showing a state of the ray tracing in the simulation of FIG. 7A, viewed from the obliquely front right side of the turn lamp (the same direction as FIG. 6B);

FIG. 8A is a simulation diagram showing, as a comparative example of FIG. 6 (A, B), ray tracing of light emitted from the light source, with respect to a turn lamp in which the cross-sectional shape of an outer peripheral face of a bend portion (the cross-sectional shape in a direction perpendicular to an optical axis at an outer circumferential side position of the bend shape) is changed from an arc shape to a quadrangular shape in the turn lamp in FIG. 4 (A to F), the turn lamp being viewed from front and obliquely above (the same direction as FIG. 6A);

FIG. 8B is a simulation diagram showing a state of the ray tracing in the simulation of FIG. 8A, viewed from the obliquely front right side of the turn lamp (the same direction as FIG. 6B);

FIG. 9A is an enlarged view of an area enclosed by a dashed line E in FIG. 3B, with respect to the turn lamp in FIG. 4 (A to F), schematically showing a path taken by light that deviates from the optical axis of the light guide portion near an incident surface; and

FIG. 9B schematically shows, as a comparative example of FIG. 9A, a path taken by light that deviates from the optical axis of the light guide portion near the incident surface in a case in which a mortar-shaped inclined surface is eliminated from the structure of FIG. 9A and is replaced with a flat surface.

### DETAILED DESCRIPTION OF THE INVENTION

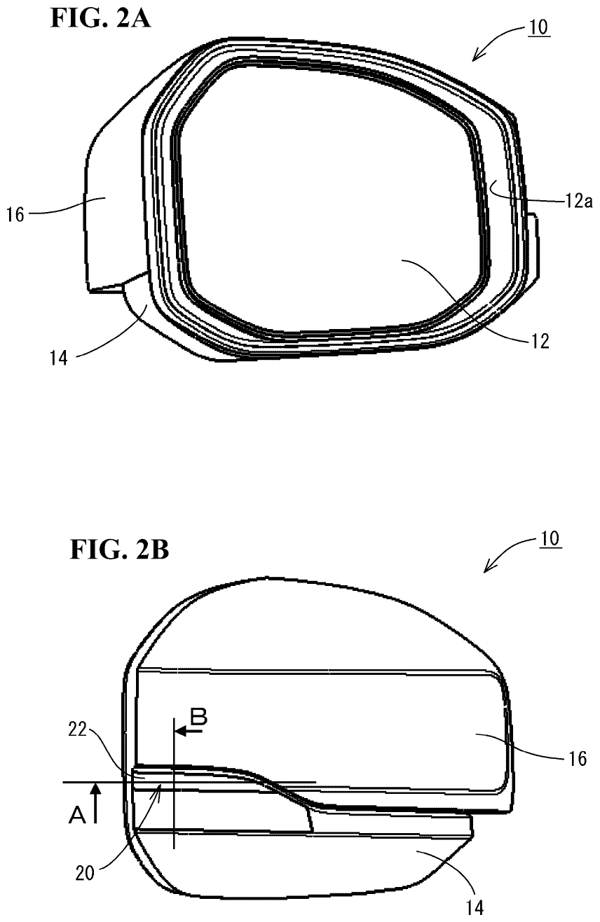

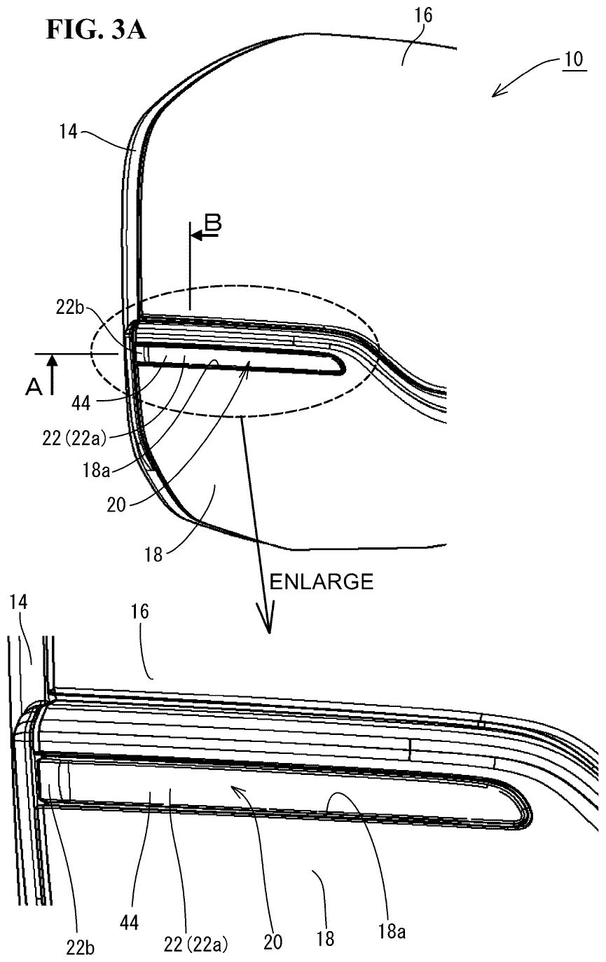

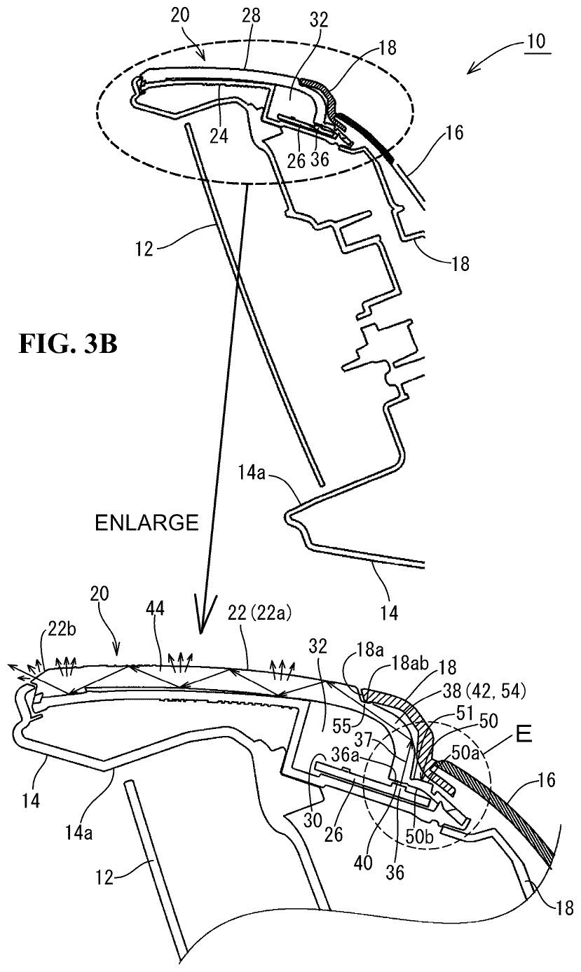

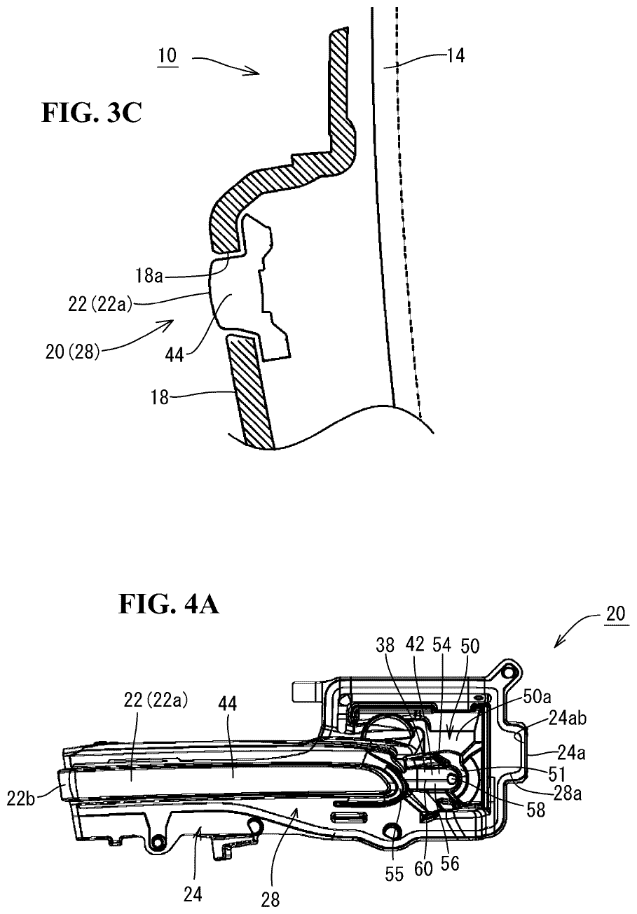

An embodiment of the present invention will be described. Here, a case in which the present invention is applied to a turn lamp to be mounted on a door mirror for a vehicle (a side mirror using a physical mirror) will be described. FIG. 2 (A, B) show a door mirror 10 for the vehicle right side equipped with the turn lamp to which the present invention is applied. FIG. 2A shows a state viewed from the front side of the door mirror 10 (vehicle rear side), and FIG. 2B shows a state viewed from the back side of the door mirror 10 (vehicle front side). FIGS. 2A and 2B both show the door mirror 10 with a lower cover 18 (FIG. 3 (A to C)) detached. The door mirror 10 includes a mirror plate 12, a mirror housing 14, an upper cover 16, the lower cover 18 (FIG. 3 (A to C)), and a turn lamp 20. The mirror plate 12 is disposed in a front opening 12a of the mirror housing 14. The turn lamp 20 is attached to a back side of the mirror housing 14. The upper cover 16 is attached to the mirror housing 14 in such a manner that the upper cover 16 covers an area above the turn lamp 20 on a back face of the mirror housing 14. The lower cover 18 (FIG. 3 (A to C)) is attached to the mirror housing 14 in such a manner that the lower cover 18 covers a lower side of the mirror housing 14. The lower cover 18 is formed with an opening 18a (FIG. 3 (A to C)) that exposes a radiation surface 22 of the turn lamp 20 (a front face of a radiation portion 44 of a light guide portion 38, which will be described later) to an external environment (atmospheric space). The opening 18a is formed with a structure in which an end on the side farther from the vehicle body is open (refer to FIG. 3A). The radiation surface 22 radiates turn signal light from a forward-facing face 22a toward the front side and the front lateral side of the vehicle and from a distal end face 22b on the side farther from the vehicle body (a distal end face of the radiation portion 44 of the light guide portion 38, which will be described later) toward the rear side and the rear lateral side of the vehicle.

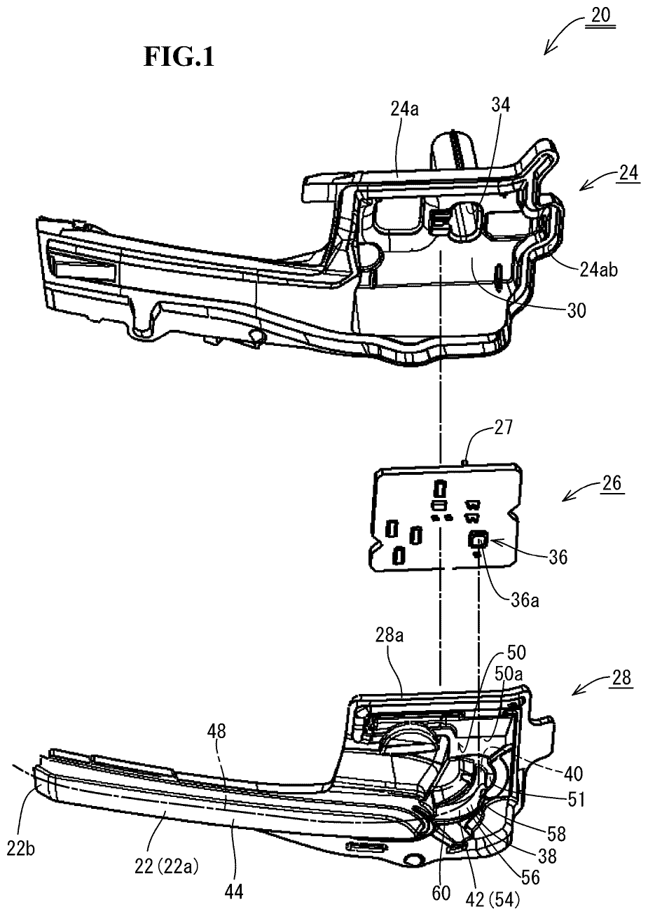

The turn lamp 20 will be described. FIG. 1 shows the turn lamp 20 disassembled into its components. The turn lamp 20 includes a lamp housing 24, a circuit board 26, and a lamp cover 28 (outer lens). The turn lamp 20 is assembled by covering the lamp housing 24 with the lamp cover 28 in a state in which the circuit board 26 is disposed and housed in a circuit board placement space 30 of the lamp housing 24, and joining the lamp housing 24 and the lamp cover 28 together at their peripheral edges using ultrasonic welding, adhesive bonding, or the like. In the assembled state of the turn lamp 20, a lamp chamber 32 (FIG. 3B) is formed between the lamp housing 24 and the lamp cover 28. The lamp chamber 32 is shielded from the external environment, except for a connector insertion port 34 (FIG. 1) for connecting a connector (not shown) to a terminal 27 on a back face of the circuit board 26. The circuit board 26 is disposed and housed in the lamp chamber 32 without rattling due to play.

In FIG. 1, the lamp housing 24 is formed of an integrally molded article made of black resin (such as ABS). On a front face of the circuit board 26 (printed circuit board), one LED 36 (light source) and other circuit elements are mounted. A light-emitting surface 36a of the LED 36 faces in a direction perpendicular to a board surface of the circuit board 26. The front shape of the light-emitting surface 36a is a circular shape that enables light emission with uniform distribution.

The lamp cover 28 is formed of an integrally molded article made of transparent resin (such as PMMA). The light guide portion 38 is integrated with the lamp cover 28. The light guide portion 38 includes an incident surface 40 that faces the light-emitting surface 36a of the LED 36 and allows light emitted from the light-emitting surface 36a to enter the light guide portion 38, a relay portion 42 that guides the light incident through the incident surface 40 and transfers the light to the radiation portion 44, and the radiation portion 44 that radiates the light transferred from the relay portion 42 toward the external environment from the forward-facing face 22a and the distal end face 22b of the radiation surface 22 while guiding the light. The incident surface 40 is formed in a circular shape having a diameter slightly larger than that of the light-emitting surface 36a of the LED 36 (refer to an enlarged view in the lower part of FIG. 3B). The relay portion 42 is formed with a bend portion 54 that bends an optical axis 48 of the light guide portion 38 with roundness. A band-shaped surface 60 is formed within the area of an arc-shaped surface 56 of the bend portion 54. The band-shaped surface 60 is formed to improve the light guiding efficiency of the light guide portion 38 by improving the light collection efficiency of the light guide portion 38 by restraining leakage of light from the light guide portion 38. In addition, the lamp cover 28 is formed with a plate-shaped portion 50 at a position facing the circuit board 26 disposed and housed in the circuit board placement space 30 of the lamp housing 24. A front face 50a of the plate-shaped portion 50 is formed with an inclined surface 51 as a light leakage prevention structure, at a position adjacent to an outer peripheral face of the light guide portion 38. The inclined surface 51 has a mortar shape concavely inclined toward the outer peripheral face of the light guide portion 38.

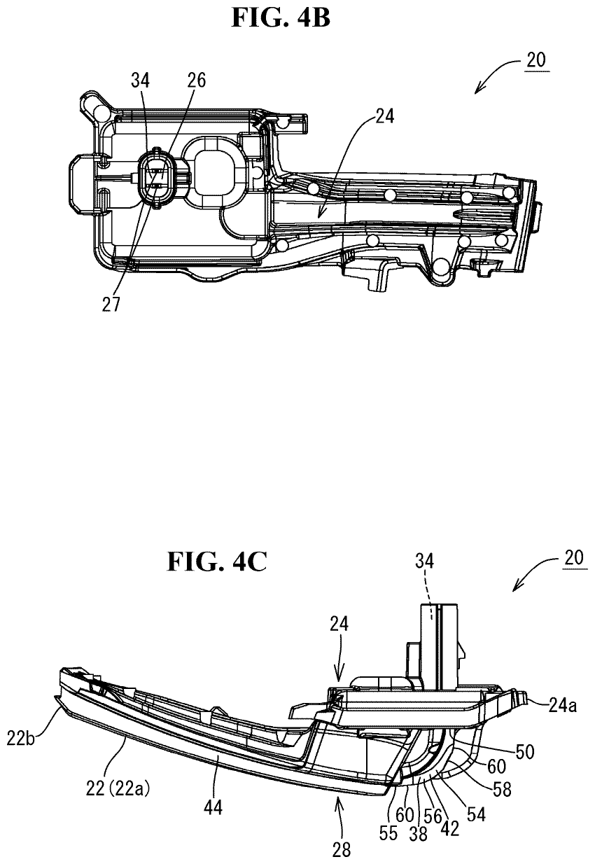

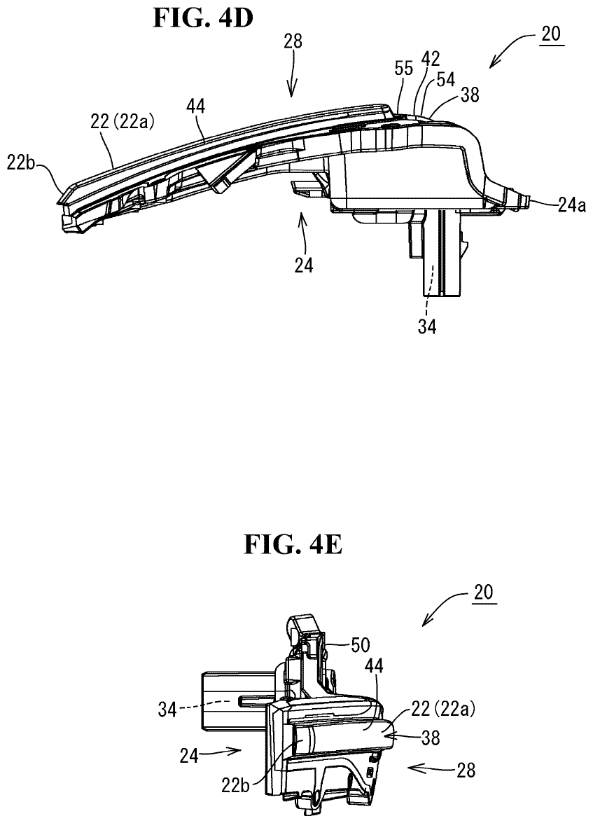

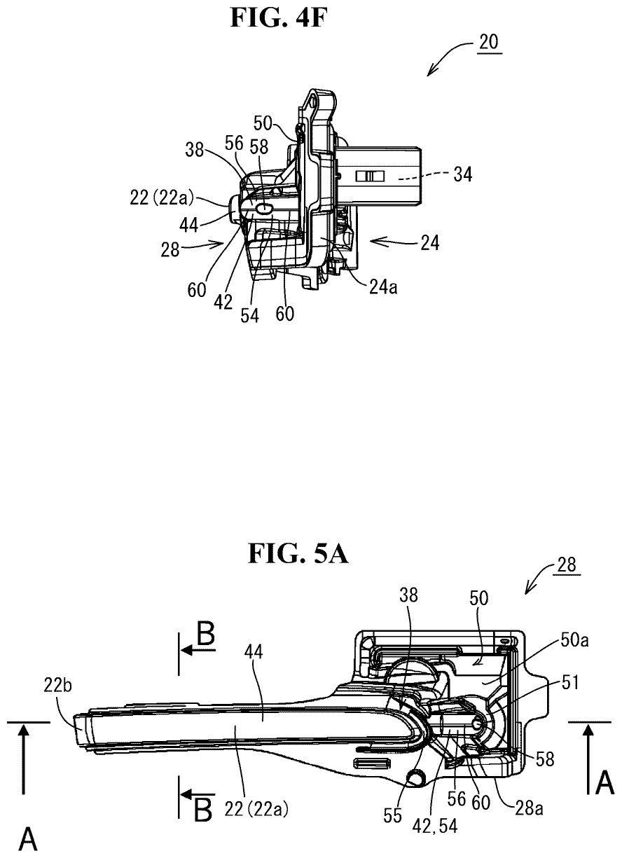

FIG. 4 (A to F) show an assembled state of the turn lamp 20 in FIG. 1. FIG. 4A is a front view, FIG. 4B is a back view, FIG. 4C is a plan view, FIG. 4D is a bottom view, FIG. 4E is a left side view, and FIG. 4F is a right side view. In FIG. 4A, an outer peripheral end face 28a (outer peripheral wall surface) of the lamp cover 28 is surrounded by and faces an inner peripheral face 24ab of an outer peripheral wall 24a of the lamp housing 24, except for the distal end face 22b of the light guide portion 38. Light that deviates from the light guide portion 38, passes through the plate surface of the lamp cover 28, and is emitted from the outer peripheral end face 28a is absorbed by the black outer peripheral wall 24a (light-blocking wall) of the lamp housing 24 or by a bonding agent (light-blocking wall, not shown) filled in a gap between the outer peripheral end face 28a and the outer peripheral wall 24a.

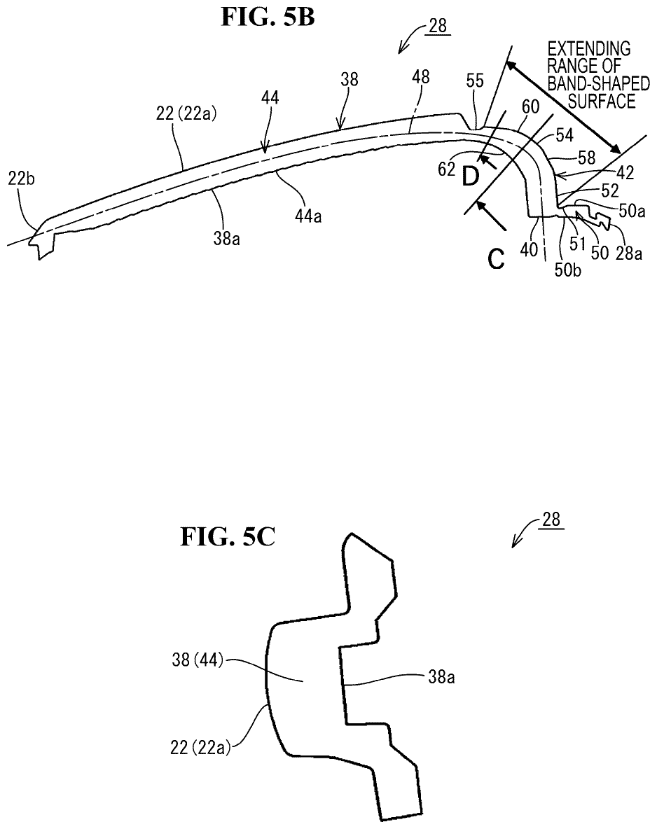

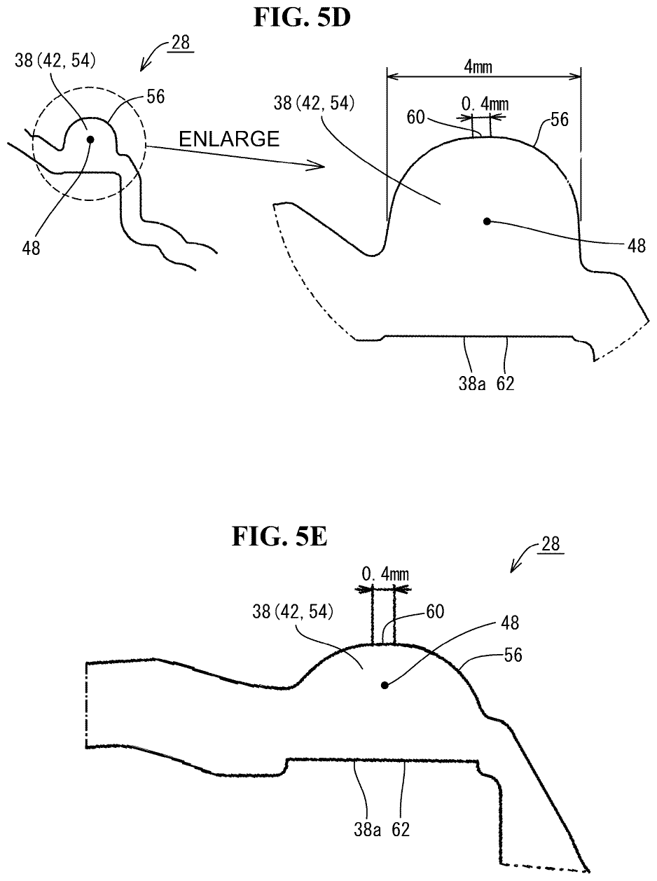

The detailed structure of the lamp cover 28 will be described. FIG. 5 (A to E) show the structure of the lamp cover 28. FIG. 5A is a front view, FIG. 5B is a sectional view at an A arrow view position in FIG. 5A, FIG. 5C is a sectional view at a B arrow view position in FIG. 5A, FIG. 5D is a sectional view at a C arrow view position in FIG. 5B and an enlarged view of an area enclosed by a dashed line in the sectional view, and FIG. 5E is a sectional view at a D arrow view position in FIG. 5B. Looking at FIG. 5A, the lamp cover 28 is joined to the lamp housing 24 (FIG. 1) at its entire outer peripheral edge. The light guide portion 38, the plate-shaped portion 50, and the like are integrated with the lamp cover 28. The lamp cover 28 is configured to have a substantially uniform plate thickness, except for the light guide portion 38. The light guide portion 38 is configured as a structure in which a recess and a projection are formed in a part of this plate surface having the uniform plate thickness.

Looking at FIG. 5B, the light guide portion 38 is configured in such a manner that the incident surface 40, the relay portion 42, and the radiation portion 44 are contiguously arranged along the optical axis 48. The relay portion 42 is configured in such a manner that a straight portion 52, the bend portion 54, and a connection portion 55 are contiguously arranged along the optical axis 48 from the incident surface 40 side. The straight portion 52 extends in a direction perpendicular to the incident surface 40. The incident surface 40 is disposed parallel to the plate surface of the plate-shaped portion 50 and flush with a back face 50b of the plate-shaped portion 50. The cross-sectional shape of the straight portion 52 in the direction perpendicular to the optical axis 48 is a circular shape.

The bend portion 54 is formed contiguous from the straight portion 52 with no step. The bend portion 54 bends the optical axis 48 at a substantially right angle with roundness. An outer peripheral face of the outer peripheral side (outer circumferential side) of a curve of the bend shape of the bend portion 54 is formed as the arc-shaped surface 56 having a convex arc cross-sectional shape perpendicular to the optical axis 48 (refer to FIGS. 5D and 5E showing sections at the C, D arrow view positions in FIG. 5B). The arc-shaped surface 56 is formed throughout the entire length of the bend portion 54 in the direction of the optical axis 48. The cross-sectional shape of the arc-shaped surface 56 perpendicular to the optical axis 48 is the same circular arc shape as the straight portion 52 at a position connected to the straight portion 52, and gradually becomes a flat elliptical shape as being away from the straight portion 52 (refer to FIGS. 5D and 5E).

A reflective surface 58 having a shape obtained by cutting the arc-shaped surface 56 flat (an elliptical shape when viewed from the front, refer to FIG. 4F) is formed at an intermediate position along the optical axis 48 of the arc-shaped surface 56. The reflective surface 58 is provided to reflect (totally reflect), in the direction of the radiation portion 44, light radiated in the front direction of the light-emitting surface 36a from the LED 36 and efficiently guide the light to the radiation portion 44.

Within the plane of the arc-shaped surface 56 (within the area of the arc-shaped surface 56), the band-shaped surface 60 is formed at an outermost peripheral position of the curve of the bend shape of the bend portion 54 (refer to FIG. 4F, FIG. 5A, etc.). The cross-sectional shape of the band-shaped surface 60 perpendicular to the optical axis 48 is formed flat (refer to FIG. 5D, FIG. 5E, etc.). The band-shaped surface 60 is formed throughout the entire length from the straight portion 52 to the bend portion 54 with the reflective surface 58 interposed therebetween, in the direction of the optical axis 48 (refer to FIGS. 4F, 5A, and 5B). By forming the band-shaped surface 60, as will be described later, it is possible to improve light guiding efficiency by restraining leakage of light from the light guide portion 38 (i.e., improving the light collection efficiency of the light guide portion 38), compared to a case in which the band-shaped surface 60 is not formed (a case in which the arc-shaped surface 56 is also present at the position of the band-shaped surface 60). The width of the band-shaped surface 60 in a section perpendicular to the optical axis 48 is desirably equal to or less than one-half (more desirably, equal to or less than one-third, and even more desirably equal to or less than one-quarter) and equal to or greater than one-twentieth (more desirably, equal to or greater than one-tenth) of the width of the arc-shaped surface 56 in the same section (here, the width of the arc-shaped surface 56 is equal to the diameter of the light guide portion 38). That is, if the width of the band-shaped surface 60 is too wide, leakage of light increases. In addition, if the width of the band-shaped surface 60 is too narrow, the effect of the band-shaped surface 60 is deteriorated. In the design of the present embodiment, as shown in FIG. 5D, the width of the arc-shaped surface 56 (the diameter of the light guide portion 38) is set to 4 mm. In this case, it is desirable to set the width of the band-shaped surface 60 to 0.2 mm to 2 mm. In the example of FIG. 5D, the width of the band-shaped surface 60 is set to 0.4 mm.

The outer peripheral face of the inner peripheral side (inner circumferential side) of the curve of the bend shape of the bend portion 54 is formed as a flat surface 62 having a flat cross-sectional shape perpendicular to the optical axis 48 (refer to FIGS. 5D and 5E). The flat surface 62 is formed in such a manner that the cross-sectional shape perpendicular to the optical axis 48 gradually changes from the arc-shaped surface of the straight portion 52 to the flat surface 62 so as to prevent formation of a step at the position connected to the straight portion 52.

The connection portion 55 is a portion formed between the bend portion 54 and the radiation portion 44. As shown in the enlarged view of FIG. 3B, the connection portion 55 is formed with a recess into which a protrusion 18ab formed on a back side of an edge of the opening 18a of the lower cover 18 is fitted and held. By the protrusion 18ab being held in the connection portion 55, the radiation portion 44 (the radiation surface 22) of the turn lamp 20 is positioned at a correct position relative to the opening 18a.

The cross-sectional shape of the radiation portion 44 perpendicular to the optical axis 48 is formed in a flat quadrangular shape (refer to FIG. 5C). The front shape of the radiation portion 44 is formed in an elongated shape that is long in the left-right direction (refer to FIG. 5A, FIG. 3A, etc.). The plane shape of the radiation portion 44 is formed in a gently curved shape following the curvature of the opening 18a (FIG. 3A) in which the radiation surface 22 is exposed (refer to FIG. 5B). As shown in FIG. 5B, a back face 38a of the light guide portion 38 is formed without a large step from the incident surface 40 to the radiation portion 44 through the relay portion 42 (the straight portion 52, the bend portion 54, the connection portion 55). However, on the back face 38a at the position of the radiation portion 44, fine ridges and valleys (a structure in which protrusions and recesses extending in the direction perpendicular to the sheet of FIG. 5B are alternately and repeatedly arranged in the direction along the optical axis 48) are formed by a lens cut 44a (also called a prism cut) throughout the entire back face of the radiation portion 44. Light guided to the radiation portion 44 is reflected by the lens cut 44a and radiated from the radiation surface 22 toward the external environment, which causes the radiation surface 22 to shine and be visually recognized from the external environment. No lens cut is formed on the back face 38a at the position of the relay portion 42 (the straight portion 52, the bend portion 54, the connection portion 55). Light reaching a distal end of the radiation portion 44 is radiated from the distal end face 22b toward the external environment.

As described above, the cross-sectional shape of the light guide portion 38 perpendicular to the optical axis 48 is a circular shape at the position of the incident surface 40, gradually becomes flat as being away from the incident surface 40, and becomes a flat quadrangular shape at the position of the radiation portion 44 where the radiation surface 22 is present. Accordingly, by allowing light emitted from the circular light-emitting surface 36a of the LED 36 to be efficiently incident through the incident surface 40, and gradually deforming the incident light having a circular cross section into a shape having a flat cross section while bending the light at a right angle at a gentle curve in the bend portion 54 to form the light into a quadrangular shape having a flat cross section at the radiation surface, it is possible to efficiently guide the light from the LED 36 to the radiation portion 44 and allow the light to be emitted from the radiation surface 22. A light path taken when light 37 emitted from the LED 36 is radiated from the radiation surface 22 is schematically shown in the enlarged view of FIG. 3B.

According to the turn lamp 20 having the above configuration, since the light guide portion 38 includes the bend portion 54, the incident surface 40 can be disposed facing forward of the turn lamp 20, as shown in FIG. 3B. As a result, since the circuit board 26 can be disposed parallel to a front face of the turn lamp 20, the thickness of the turn lamp in the front-rear direction can be made thinner than that in a structure in which the light guide portion includes no bend portion and the incident surface is disposed at a right angle relative to the front face of the turn lamp (the circuit board is also disposed at a right angle relative to the front face of the turn lamp, for example, the structure described in U.S. Pat. No. 8,475,018). Thus, the turn lamp 20 can be easily assembled to the door mirror 10 without interfering with other devices to be assembled to the door mirror 10 (such as a mirror surface actuator, another lamp, a camera, etc.). In addition, as shown in FIG. 3B, in a state in which the turn lamp 20 is assembled to the door mirror 10, the bend portion 54, the incident surface 40, the inclined surface 51, and the like are disposed at a position that is hidden behind the cover (the lower cover 18 or the upper cover 16) and is not visible from the external environment. Thus, the bend portion 54, the incident surface 40, the inclined surface 51, and the like do not impair the design of the turn lamp 20.

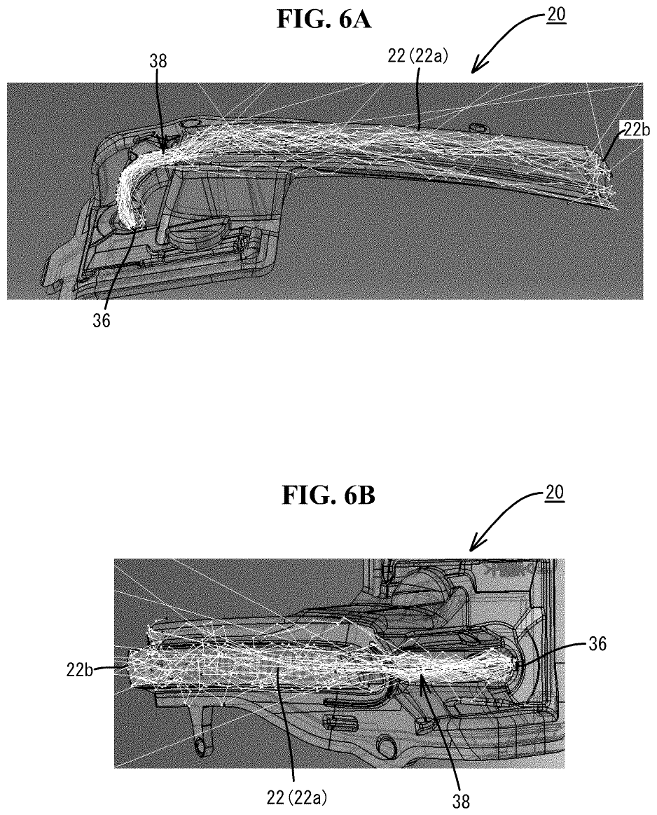

The effect of the band-shaped surface 60 formed within the area of the arc-shaped surface 56 of the light guide portion 38 will be described. FIG. 6 (A, B) are simulation diagrams showing ray tracing of light emitted from the LED 36, with respect to the turn lamp 20. FIG. 6A shows the turn lamp 20 when viewed from front and obliquely above, and FIG. 6B shows the turn lamp 20 when viewed from the obliquely front right side. Light emitted from the LED 36 is guided through the light guide portion 38 and radiated to the external environment from the forward-facing face 22a and the distal end face 22b of the radiation surface 22.

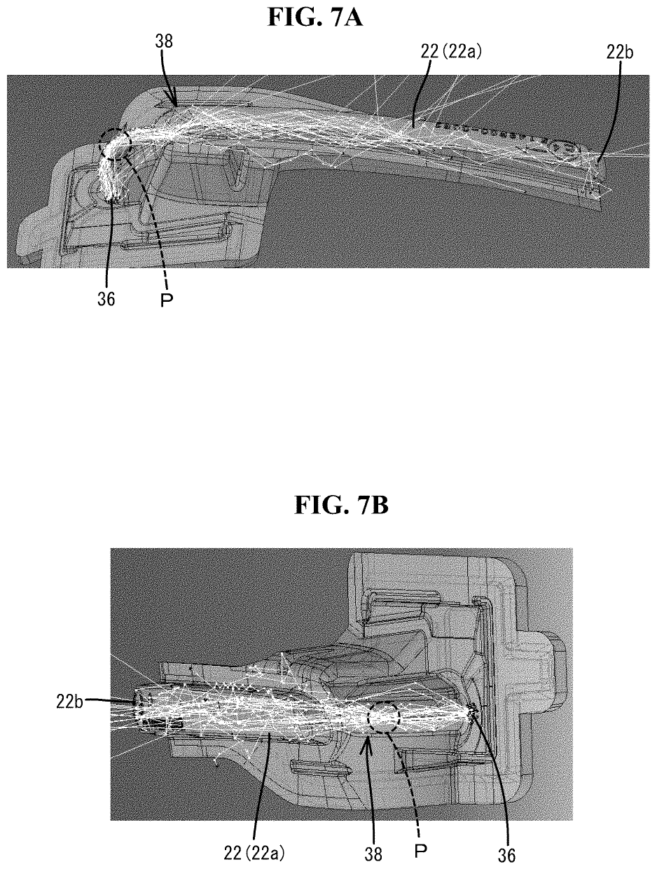

FIG. 7 (A, B) are simulation diagrams showing, as a comparative example, ray tracing of light emitted from the LED 36, with respect to a turn lamp in which the band-shaped surface 60 of the light guide portion 38 of the turn lamp 20 is eliminated (a place of the band-shaped surface 60 is also formed as the arc-shaped surface 56). FIGS. 7A and 7B are viewed from the same directions as FIGS. 6A and 6B, respectively. When comparing FIG. 6A and FIG. 7A, it can be seen that the amount of light guided to the distal end face 22b of the radiation surface 22 of the light guide portion 38 in FIG. 7A is smaller than that in FIG. 6A. Although the reason for the reduction in the amount of light guided to the distal end face 22b in FIG. 7A is not clear, when comparing FIG. 6 (A, B) and FIG. 7 (A, B), rays of light concentrate at a single point and cross within an area enclosed by a dashed line P on the bend portion 54 in FIG. 7 (A, B). This may increase light leaking from the light guide portion 38. In other words, in FIG. 6 (A, B), the band-shaped surface 60 (e.g., FIG. 4A) restrains rays of light from concentrating at a single point in the bend portion 54, which may result in less light leakage from the light guide portion 38.

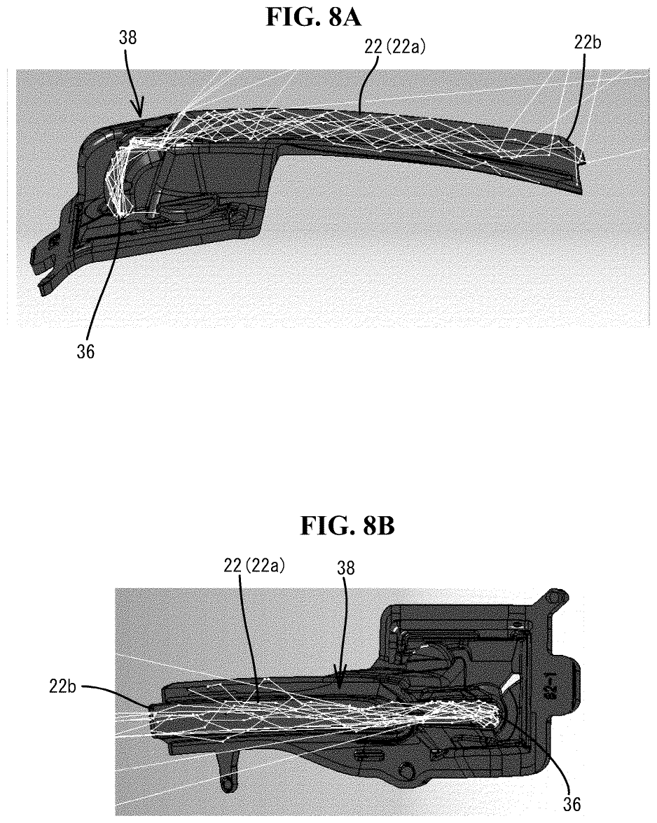

FIG. 8 (A, B) are simulation diagrams showing, as a comparative example, ray tracing of light emitted from the LED 36, with respect to a turn lamp in which the cross-sectional shape of the outer peripheral face of the bend portion 54 of the light guide portion 38 of the turn lamp 20 (the cross-sectional shape in the direction perpendicular to the optical axis at the outer peripheral side (outer circumferential side) position of the curve of the bend shape) is changed from an arc shape to a quadrangular shape. FIGS. 8A and 8B are viewed from the same directions as FIGS. 6A and 6B, respectively. When comparing FIG. 6A and FIG. 8A, it can be seen that the amount of light guided to the distal end face 22b of the radiation surface 22 of the light guide portion 38 in FIG. 8A is significantly smaller than that in FIG. 6A.

In this way, it can be understood that forming the band-shaped surface 60 within the area of the arc-shaped surface 56 of the light guide portion 38 restrains leakage of light in the middle of light guidance of the light guide portion 38 (i.e., improves the light collection efficiency of the light guide portion), which improves light guiding efficiency. Thus, it becomes possible to reduce the number of LEDs 36 or use the LED 36 with a relatively low output, and solve the problems in cost and heat generation.

The inclined surface 51 (FIGS. 1, 3B, 4A, and 5A) formed on the plate-shaped portion 50 of the lamp cover 28 as the light leakage prevention structure will be described. The front face 50a of the plate-shaped portion 50 is formed with the mortar-shaped inclined surface 51 that is concavely inclined toward the outer peripheral face of the light guide portion 38 at the position that surrounds the light guide portion 38 adjacent to the outer peripheral face of the light guide portion 38. The shape of the inclined surface 51 viewed from the front of the lamp cover 28 is a circular shape (refer to FIGS. 4A and 5A). The inclined surface 51 constitutes the light leakage prevention structure, and is formed to prevent light deviating from the light guide portion 38 near the incident surface 40 from penetrating (passing through) the plate-shaped portion 50 and leaking to the outside of the turn lamp 20 by totally reflecting the light deviating from the light guide portion 38 and guiding the light into the plate surface of the plate-shaped portion 50. An inclination angle of the inclined surface 51 relative to the front face 50a of the plate-shaped portion 50 is set to an angle at which all or part of the light directly applied to the inclined surface 51 from the LED 36 is totally reflected by the inclined surface 51.

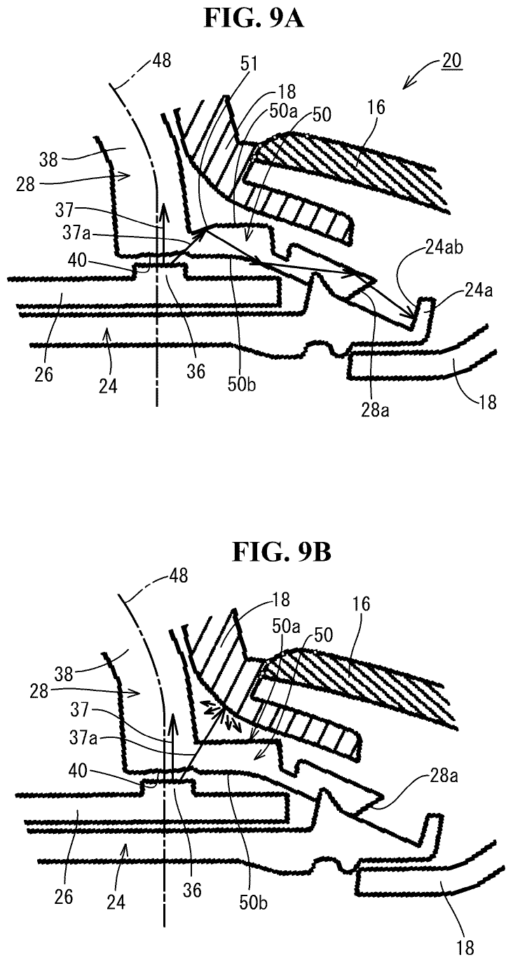

A light leakage prevention operation performed by the inclined surface 51 will be described. FIG. 9A is an enlarged view of an area enclosed by a dashed line E in FIG. 3B, with respect to the turn lamp 20, schematically showing a path taken by light 37a that deviates from the optical axis 48 of the light guide portion 38 near the incident surface 40. The light 37a deviating from the optical axis 48 is totally reflected by the inclined surface 51, passes through the inside of the plate surface of the plate-shaped portion 50, reaches the outer peripheral end face 28a of the plate-shaped portion 50, and is absorbed (blocked) by the inner peripheral face 24ab of the outer peripheral wall 24a of the black lamp housing 24 facing the outer peripheral end face 28a (or the bonding agent (not shown) filled in the gap between the outer peripheral end face 28a and the inner peripheral face 24ab). Thus, it is possible to restrain the light 37a deviating from the optical axis 48 from penetrating the plate-shaped portion 50 and leaking to the outside of the turn lamp 20.

FIG. 9B schematically shows, as a comparative example, a path taken by the light 37a that deviates from the optical axis 48 of the light guide portion 38 near the incident surface 40 in a case in which the mortar-shaped inclined surface 51 is eliminated from the structure of FIG. 9A and is replaced with a flat surface. Since there is no inclined surface, the light 37a that deviates from the optical axis 48 penetrates (passes through) the plate-shaped portion 50 and leaks to the outside of the turn lamp 20. The light leaking to the outside of the turn lamp 20 may be reflected inside the door mirror 10 and leak to the external environment, and may be visually recognized. Thus, in this case, it is necessary to take measures such as disposing a light-blocking sheet on the plate-shaped portion 50 to block the light that has penetrated the plate-shaped portion 50.

In the above embodiment, the incident surface 40 of the light guide portion 38 is disposed substantially flush with the back face of the plate-shaped portion 50. However, the present invention is also applicable to a light guide structure in which the incident surface 40 is disposed non-flush with the back face of the plate-shaped portion 50 (e.g., the incident surface 40 is disposed protruding into the lamp chamber 32).

In the above embodiment, the incident surface 40 of the light guide portion 38 is disposed parallel to the plate surface of the plate-shaped portion 50. However, the present invention is also applicable to a structure in which the incident surface 40 is disposed non-parallel to the plate surface of the plate-shaped portion 50.

The above embodiment describes the configuration in which the light guide portion is integrated with the lamp cover. However, the present invention is also applicable to a configuration in which the light guide portion is configured as a component separate from the lamp cover. In that case, the plate-shaped portion may be configured as a plate-shaped member that is separate from the lamp cover and connected to one end of the light guide portion.

The above embodiment describes the case in which the present invention is applied to the turn lamp including the light guide portion having the bend portion. However, the present invention is also applicable to a turn lamp including a light guide portion having no bend portion.

The above embodiment describes the case in which the present invention is applied to the turn lamp including one LED. However, the present invention is also applicable to a turn lamp including two or more light sources, or to a turn lamp including a light source other than a LED.

The above embodiment describes the case in which the turn lamp including the light guide structure of the present invention is mounted on the physical type side mirror for a vehicle. However, the turn lamp including the light guide structure of the present invention may also be mounted on an electronic type side mirror (a side mirror using a camera). In addition, the present invention is also applicable to a turn lamp mounted on a place on a vehicle other than the side mirror.

1. A light guide structure of a side turn signal lamp, the light guide structure comprising:
a light guide portion incorporated in a side turn signal lamp, the light guide portion being configured to allow light from a light source of the side turn signal lamp to enter the light guide portion through a predetermined incident surface, guide the light, and radiate the light toward an external environment from a predetermined radiation surface; and
a light leakage prevention structure, wherein
the light leakage prevention structure includes a plate-shaped portion integrated with the light guide portion in such a manner that the plate-shaped portion is connected to one end side of the light guide portion where the incident surface is disposed and extends in a plane direction parallel or non-parallel to the incident surface, and
the plate-shaped portion includes an inclined surface on a front face of the plate-shaped portion at a position adjacent to an outer peripheral face of the light guide portion, the inclined surface being concavely inclined toward the outer peripheral face of the light guide portion.

2. The light guide structure according to claim 1, wherein the incident surface has a circular shape, and the inclined surface is formed in a mortar shape surrounding the incident surface.

3. The light guide structure according to claim 1, further comprising a light-blocking wall disposed facing an outer peripheral end face of the plate-shaped portion.

4. The light guide structure according to claim 1, wherein the light guide portion includes a bend portion that bends an optical axis of the light guide portion with roundness in such a manner that the incident surface faces forward or obliquely forward of the side turn signal lamp.

5. The light guide structure according to claim 4, wherein the incident surface and the inclined surface are disposed at a position that is not visible from the external environment in a state in which the side turn signal lamp is mounted on a vehicle.

6. The light guide structure according to claim 1, wherein
the plate-shaped portion constitutes a part of a lamp cover, the lamp cover being attached to and covering a lamp housing in which a circuit board equipped with the light source is disposed in the side turn signal lamp to form a lamp chamber between the lamp cover and the lamp housing and to shield the lamp chamber from the external environment, and
the plate-shaped portion is disposed facing the circuit board and the incident surface is disposed facing the light source in a state in which the lamp cover is attached to and covers the lamp housing.

7. The light guide structure according to claim 6, wherein an outer peripheral end face of the plate-shaped portion is disposed facing an inner peripheral face of an outer peripheral wall of the lamp housing in a state in which the lamp cover is attached to and covers the lamp housing.
